(19) United States
(12) Patent Application Publication
(10) Pub. No.: US 2025/0343591 A1
(43) Pub. Date: Nov. 6, 2025

(54) METHOD, DEVICE AND COMPUTER READABLE MEDIUM FOR COMMUNICATIONS

(71) Applicant: NEC Corporation, Tokyo (JP)

(72) Inventors: Xincai LI, Beijing (CN); Gang WANG, Beijing (CN)

(73) Assignee: NEC Corporation, Tokyo (JP)

(21) Appl. No.: 18/993,363

(22) PCT Filed: Jul. 12, 2022
(86) PCT No.: PCT/CN2022/105157

§ 371 Date: Jan. 10, 2025

(51) Int. Cl. H04B 7/06; H04B 17/318; H04W 72/23

(52) U.S. Cl. CPC H04B 7/06964; H04B 7/0626; H04B 7/06968; H04B 17/328; H04W 72/23

(57) ABSTRACT

Embodiments of the present disclosure relate to methods, devices and computer readable media for communications. According to embodiments of the present disclosure, a first terminal device performs a CLI measurement associated with a transmit beam of a first network device on a Sounding Reference Signal (SRS) received from a second terminal device. Then, the first terminal device performs a Beam Failure Detection (BFD) procedure based on the CLI measurement.

### FIELD

Embodiments of the present disclosure generally relate to the field of communications, and in particular, to a method, device and computer readable medium for a Beam Failure Recovery (BFR) procedure under Cross Link Interference (CLI).

### BACKGROUND

In some cases, movements in the environment or other events, may lead to a currently beam pair established between a network device and a terminal device served by the network device being rapidly blocked without sufficient time for the regular beam adjustment to adapt. The New Radio (NR) specification includes specific procedures to handle such beam-failure events, also referred to as beam (failure) recovery.

With development of the communication technology, the density of deployment for network devices and serving cells becomes quite high. In this case, the communication of another device adjacent to the terminal device may interfere with data transmission between the terminal device and the network device. For example, during performing downlink reception from the network device, the terminal device may be interfered if the other device transmits uplink data simultaneously, which is also referred to Cross Link Interference (CLI). Accordingly, the CLI may affect the quality of a radio link formed by the beam pair established between the network device and the terminal device.

### SUMMARY

In general, example embodiments of the present disclosure relate to methods, devices and computer readable media for the BFR procedure under CLI.

In a first aspect, there is provided a communication method. In the method, a first terminal device performs a CLI measurement associated with a transmit beam of a first network device on a Sounding Reference Signal (SRS) received from a second terminal device. Then, the first terminal device performs a Beam Failure Detection (BFD) procedure based on the CLI measurement.

In a second aspect, there is provided a communication method. In the method, a first network device determines a CLI elimination configuration based on a CLI measurement report from a first terminal device. Then, the first network device transmits a CLI elimination configuration for the second terminal device to a second network device serving the second terminal device. The CLI elimination configuration indicates a list of candidate beams for the first terminal device, the candidate beams are disabled for the second terminal device.

In a third aspect, there is provided a communication method. In the method, a second network device transmits a SRS resource configuration for a second terminal device to a first network device. The second network device receives a CLI elimination configuration for the second terminal device. The CLI elimination configuration indicates a list of candidate beams for the first terminal device. The candidate beams are disabled for the second terminal device. Then, the second network device transmits the CLI elimination configuration to the second terminal device.

In a fourth aspect, there is provided a terminal device. The terminal device comprises a processor and a memory coupled to the processor and storing instructions thereon, the instructions, when executed by the processor, causing the terminal device to perform the method of the first aspect.

In a fifth aspect, there is provided a network device. The network device comprises a processor and a memory coupled to the processor and storing instructions thereon, the instructions, when executed by the processor, causing the network device to perform the method of any one of the second aspect to the third aspect.

In a sixth aspect, there is provided a computer readable medium having instructions stored thereon, the instructions, when executed on at least one processor, causing the at least one processor to perform the method of any one of the first aspect to the third aspect.

It is to be understood that the summary section is not intended to identify key or essential features of example embodiments of the present disclosure, nor is it intended to be used to limit the scope of the present disclosure. Other features of the present disclosure

### BRIEF DESCRIPTION OF THE DRAWINGS

Some example embodiments will now be described with reference to the accompanying drawings, where:

FIG. 1 illustrates an example environment in which some embodiments of the present disclosure can be implemented;

FIG. 2 illustrates a signaling process of a BFR procedure according to some embodiments of the present disclosure;

FIG. 3 illustrates an example resource configuration according to some embodiments of the present disclosure;

FIG. 4 illustrates a flowchart of an example method according to some embodiments of the present disclosure;

FIG. 5 illustrates a flowchart of an example method according to some embodiments of the present disclosure;

FIG. 6 illustrates a flowchart of an example method implemented at a first terminal device according to some embodiments of the present disclosure;

FIG. 7 illustrates a flowchart of an example method implemented at a first network device according to some embodiments of the present disclosure;

FIG. 8 illustrates a flowchart of an example method implemented at a second network device according to some embodiments of the present disclosure; and

FIG. 9 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may be also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHZ-7125 MHz), FR2 (24.25 GHz to 71 GHz), 71 GHz to 114 GHz, and frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As mentioned above, the CLI may affect the quality of a radio link formed by the beam pair established between the network device and the terminal device. Especially in the situation with extremely high radio signal density (for example, the network device operating in a sub-band basis duplex mode, in which the network device may transmit and receive the radio signals simultaneously), the BFR procedure may be caused by the CLI mainly. In turn, enhancing the BFR procedure with respect to CLI is beneficial. In addition, the resource configuration for the BFR procedure with CLI is also a key aspect.

The example embodiments of this disclosure propose a mechanism for the BFR procedure under CLI. In the mechanism, a first terminal device performs a CLI measurement associated with a transmit beam of a first network device on a Sounding Reference Signal (SRS) received from a second terminal device. Then, the first terminal device performs a Beam Failure Detection (BFD) procedure based on the CLI measurement.

In this way, the BFR procedure may be performed purposefully in case of the Beam Failure (BF) being caused by CLI mainly. As such, the BRF procedure may be performed by eliminating effect of the CLI, and the Beam Failure Detection or the determination of candidate beams may be also performed considering the effect of the CLI.

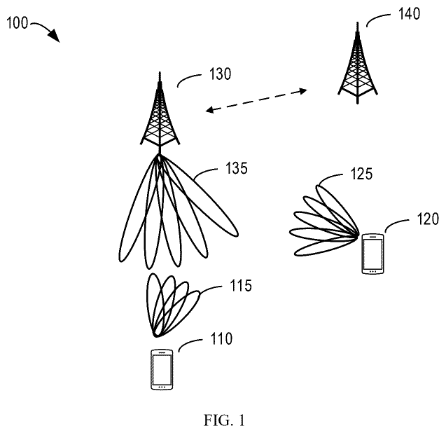

FIG. 1 illustrates an example environment 100 in which example embodiments of the present disclosure can be implemented.

The environment 100, which may be a part of a communication network, comprises a first terminal device 110, a second terminal device 120, a first network device 130 and a second network device 140. Without any limitation, the terminal devices and network devices in FIG. 1 are capable of performing data transmission in different spatial directions based on multi-beams capability. In the example of FIG. 1, the first network device 130 serves the first terminal device 110 and the second network device 140 serves the second terminal device 120. In some embodiments, the second terminal device 120 may be a terminal device adjacent to the location of the first terminal device 110.

For discussion clarity, a set of receive beams 115 of the first terminal device 110, a set of transmit beams 125 of the second terminal device 120 and a set of transmit beams 135 of the first network device 130 are shown. For example, the first terminal device 110 may perform Downlink (DL) reception from the first network device 130 via a beam of the set of receive beams 115. The first network device 130 may perform DL transmission to the first terminal device 110 via a beam of the set of transmit beams 135. The second terminal device 120 may perform Uplink (UL) transmission to the second network device 140 via a beam of the set of transmit beams 125. In some cases, during the first terminal device 110 receiving DL data via the beam of the set of beams 115, the second terminal device 120 transmits UL data via the beam of the set of beams 125. The DL reception of the first terminal device 110 may experience the CLI from the UL transmission of the second terminal device 120, if the set of beams 135 overlap at least partially with the set of beams 125 in the spatial.

It is to be understood that the number of terminal devices and network device is shown in the environment 100 only for the purpose of illustration, without suggesting any limitation to the scope of the present disclosure. In some embodiments, the environment 100 may comprise a further terminal device to communicate information with a further network device.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

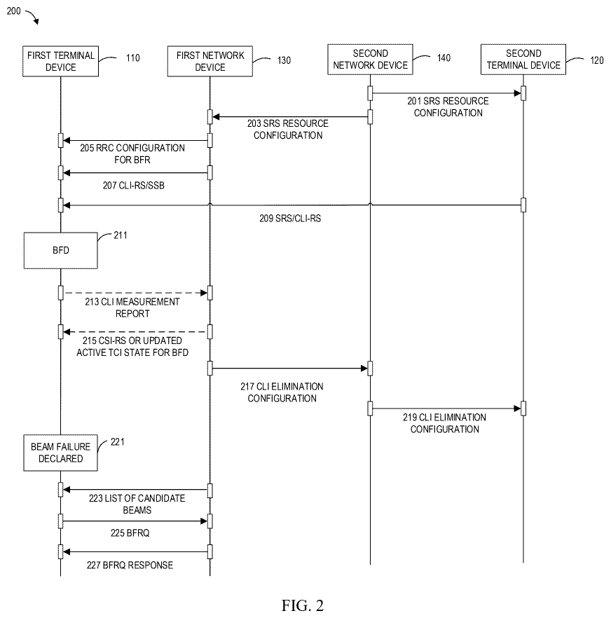

FIG. 2 illustrates a signaling process 200 of a BFR procedure according to some embodiments of the present disclosure. For purpose of discussion, the process 200 will be described with reference to FIG. 1.

At 201, in an example, the second network device 140 transmits a SRS resource configuration to the second terminal device 120. The SRS resource configuration indicates a set of resources for the second terminal device 120, the set of resource is configured for transmitting SRS by the second terminal device 120. The first terminal device 110 may perform a CLI measurement based on the SRS transmitted by the second terminal device 120. For example, the first terminal device 110 may measure a SRS receiving power (for example, a RSRP associated with the SRS) of the SRS transmitted by the second terminal device 120. In another example, the first terminal device 110 may measure a CLI-Received Signal Strength Indicator (RSSI) based on the SRS transmitted by the second terminal device 120.

In some embodiments, the SRS may be Quasi-Colocation (QCL) with a transmit beam of the first network device 130, for example, a beam of the set of transmit beams 135. Then, the first terminal device 110 may determine a CLI affected magnitude/level/size on the corresponding transmit beam of the first network device 130 based on the QCL SRS. In an example, QCL may be the type-D QCL. In other embodiments, the QCL may any other QCL type associated with spatial filter. In addition or alternatively, the SRS resource configuration for the CLI measurement may be preconfigured. Without configured by the second network device 140, the second terminal device 120 may transmit a set of SRSs on the preconfigured SRS resources for the CLI measurement.

At 203, the second network device 140 transmits the SRS resource configuration to the first network device 130. In some embodiments, the second network device 140 transmits the SRS resource configuration to the first network device 130 through Xn interface or Access and Mobility Management Function (AMF). In addition or alternatively, as discussed above, the SRS resource configuration is preconfigured. In this case, the SRS configuration is not required to be transmitted from the second network device 140 to the first network device 130.

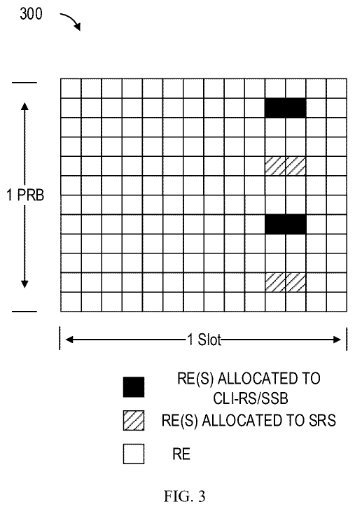

At 205, the first network device 130 transmits a Radio Resource Control (RRC) Configuration for the BFR procedure to the first terminal device 110. In some embodiments, the RRC configuration may comprise the SRS resource configuration for the CLI measurement. The SRS resource indicated in the SRS resource configuration may be multiplexed with the resource allocated to at least one of the Channel State Information (CSI)-Reference Signal (RS) or Synchronization Signal Block (SSB) of the first network device 130. In addition or alternatively, the first network device 130 may transmit a resource configuration indicating a first resource allocated to the SRS and a second resource allocated to the at least one of the CSI-RS or the SSB. The first resource and the second resource are multiplexed in the frequency domain. For example, the CSI-RS/SSB resource for DL Channel Quality Index (CQI) measurement and the SRS/CLI-Interference Management (IM) resource for CLI measurement is Frequency Division Multiplexing (FDM), where FDM method means using different frequency offset or different subband/RB set/comb. For same operator, the SRS/CSI-RS resource configuration can be exchanged between Transmit Receive Points (TRP). For different operators, the FDM resource can be divided firstly, and each operator use predefined resource. For example, for time duration t1, comb k=4 or comb=8 is used, and operator 1 or cell 1 use comb #1, operator 2 or cell 2 use comb #2, and so on. As such, with the FDM for the first resource and the second resource, the first terminal device 110 may perform CSI measurement between the first terminal device 110 and the first network device 130, and perform CLI measurement caused by the second terminal device 120 simultaneously. For discussion clarity, the resource configuration for the SRS resource and the CSI-RS/SSB resource is discussed with reference to FIG. 3.

FIG. 3 illustrates an example resource configuration 300 according to some embodiments of the present disclosure.

In FIG. 3, an example Physical Resource Block (PRB) is shown. Each block element in the PRB represents a Resource Element (RE) in the PRB. The block elements with slash represent the REs allocated to the second terminal device 120 for transmitting the SRSs, and the block elements with black shadow represent the REs allocated to the first network device 130 for transmitting the at least one of the CSI-RS and the SSB. In this case, the first resource comprises a first RE set in a Resource Block (RB), and the second resource comprises a second RE set in the RB. The first RE set is different from the second RE set. In addition, with this configuration, the terminal device 110 is able to measure CSI-RS for DL CQI/CSI channel quality and measure the SRS-SINR at the same time. Further, the above embodiments can be also expressed as following:

The UE expects single-port CSI-RS and the CLI
SRS are multiplexed on the same RB(s)
and symbol(s), but occupy different RE.

Referring back to FIG. 2, at 207, the terminal device 110 may perform CSI/CQI measurement on the CSI-RS/SBS transmitted from the first network device 130 based on the resource configuration as discussed above. At 209, the terminal device 110 performs a CLI measurement associated with a transmit beam of the first network device 130 on a SRS/Cross Link Interference-Reference Signal (CLI-RS) received from the second terminal device 120 based on the resource configuration discussed above. As mentioned above, the steps 207 and 209 can be performed simultaneously. In this case, the terminal device 110 may perform and complete the DL link measurement and the CLI measurement at the same time.

In some embodiments, the SRS resource and the CSI-RS/SSB resource are preconfigured (for example, the resource configuration as shown in the FIG. 3 is preconfigured), the terminal device 110 may also perform the DL link measurement and the CLI measurement at the same time without receiving the resource configuration from the first network device 130. In addition or alternatively, the resource configuration may be indicated to the first terminal device 110 in any other way, and then the first terminal device 110 may perform the DL link measurement and the CLI measurement accordingly.

Based on the DL link measurement, the terminal device 110 may determine the Beam Failure (BF) is happening or not, then declare the beam failure if the BF is determined to happen. In an example, during a Beam Failure Detection (BFD) procedure, whether the BF happens or not is determined based on a Beam Failure Instance (BFI) counter which is used for counting the number of BFIs associated with a set of transmit beams of the first network device 130 during a certain time period. Once the counted number reaches the maximum number of the BFI counter, the BF is declared to happen. Regarding the BFI, a BFI indication may be reported by the terminal device 110 to a higher layer based on a measurement parameter on the transmit beam being lower or higher than a threshold. Upon receiving the BFI indication during the certain time period, the BFI counter increments by one. In addition, there may be a timer for constraining the certain time period, and if the timer reaches the expiration time, the certain time period stops and the BFI counter is reset. In some other embodiments of this disclosure, the criterion for determining whether a BF happens under the CLI situation may be adjusted. For discussion simplicity in this embodiment, the criterion adjustment is discussed in the following.

The measurement parameter for triggering a BFI report may comprise Physical Downlink Control Channel (PDCCH) hypothetical Block Error Rate (BLER) of a beam. The PDCCH hypothetical BLER is estimated based on the measurement associated with the beam, for example, the RSRP/SINR of the CSI-RS/SSB QCLed with the transmit beam. If the PDCCH hypothetical BLER is above a threshold, this beam may be considered as a failure beam, and the first terminal device 110 may report the corresponding BFI to a higher layer if all the detected beams above the threshold or all the detected beams are considered as the failure beams. In the CLI situation, a CLI affected magnitude may contribute a prominent component of the PDCCH hypothetical BLER associated with a beam. The CLI affected magnitude may be an estimated value or a measured value associated with the CSI measurement on the transmit beam of the first network device 130, and the estimated value or the measured value is caused by the presence of the CLI.

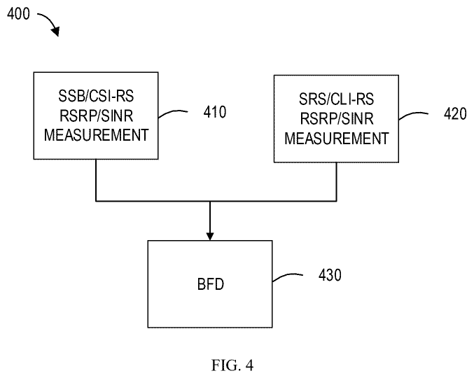

In some embodiments, for obtaining an actual BFD result that is not affected by the CLI (the CLI may be the prominent contributor to the BF), the CLI-affected magnitude may be separated from the estimated value or the measured value associated with the beam. In an example, the first terminal device 110 may extract a CLI-affected magnitude from the PDCCH hypothetical BLER calculated for the transmit beam to obtain an actual PDCCH hypothetical BLER. Then, the first terminal device 110 performs the BFD procedure based on the actual PDCCH hypothetical BLER for the transmit beam. In this way, the number of reported BFIs which comprise a large amount of BFIs caused by the CLI (similar to a “False Alarm” in signal detection) may be decreased. As such, the terminal device 110 may perform well-directed other operations to eliminate the CLI, without performing the BFR procedure. In some embodiments, the first terminal device 110 may first estimate the CLI from the SRS measurement, and then the CLI will be extracted from the hypothetical BLER calculation for PDCCH. For discussing clarity, the extraction of CLI-affected magnitude may be discussed with reference to FIG. 4.

FIG. 4 illustrates a flowchart 400 of an example method according to some embodiments of the present disclosure.

In FIG. 4, at 410, the first terminal device 110 performs the measurement on RSRP/SINR of at least one of SSB and CSI-RS transmitted from the first network 130. At 420, the first terminal device 110 performs the measurement on RSRP/SINR of at least one of SRS and CLI-RS transmitted from the second terminal device 120. In some embodiments, steps 410 and steps 420 are performed simultaneously. At 430, the first terminal device 110 performs the BFD procedure based on the CLI measurement. In the BFD procedure, the first terminal device 110 extracts the CLI-affected magnitude from the hypothetical BLER calculation for PDCCH associated with a beam. In some embodiments, the beam comprises the transmit beam of the first network device 130 and/or the receive beam of the first terminal device 110. In addition or alternatively, the above embodiments may be expressed as below.

UE assesses the radio link quality according to
SS/PBCH blocks on the PCell or the PSCell
or periodic CSI-RS resource configurations and
the SRS resource or the CLI measurement
resource for UE-to-UE CLI measurement that
are quasi co-located, as described in [6, TS 38.214], with
the DM-RS of PDCCH receptions monitored by the UE.

Referring back to FIG. 2, based on the measurement performed on the SRS/CLI-RS transmitted from the second terminal device 120, at step 213, the first terminal device 110 may generate and transmit a CLI measurement report to the first network device 130. In some embodiments, the CLI measurement report may comprise a first beam indication that is indicative of a first set of transmit beams of the first network device 130, a SRS receiving power or a CLI-Received Signal Strength Indicator (RSSI) associated with a transmit beam of the first set of transmit beams being above a first threshold. The first beam indication indicates a set of transmit beams that are affected significantly by the CLI from the second terminal device 120. In additional or alternatively, in some embodiments, one of the first set of transmit beams may be determined based on a receiving power of the SRS (or RSRP of the received SRS and/or CLI-RS) that is QCL with the transmit beam is above a threshold power (which may be also referred to as a third threshold power). If the SRS receiving power is above the third threshold power, the transmit beam of the first network device 130 that is QCL with the SRS is classified into the first set of transmit beams. The value of the third threshold power may equal to or different from the value of the first threshold. In addition or alternatively, one of the first set of transmit beams may be determined based on a Signal to Interference plus Noise Ratio (SINR) of transmit beam is below a threshold. If the SINR of the transmit beam is below the threshold, the transmit beam is classified into the first set of transmit beams.

In addition or alternatively, the CLI measurement report may comprise a second beam indication that is indicative of a second set of transmit beams of the first network device 130, a SRS receiving power or CLI-RSSI associated with a transmit beam of the first transmit beams being lower than a second threshold. The second beam indication indicates a set of transmit beams that are not affected significantly by the CLI from the second terminal device 120. In some embodiments, the second set of transmit beams may be transmit beams of the first network device 130 other than the first set of transmit beams.

In addition or alternatively, in some embodiments, one of the second set of transmit beams may be also determined based on a SRS receiving power of the SRS (or RSRP of the received SRS and/or CLI-RS) that is QCL with the transmit beam is below a threshold power (which may be also referred to as a fourth threshold power). The value of the fourth threshold power may equal to or different from the value of the second threshold. In addition or alternatively, in some embodiments, one of the second set of transmit beams may be determined based on a Signal to Interference plus Noise Ratio (SINR) of transmit beam is above a threshold (which may be also referred to as a fifth threshold power).

At 215, the first network device 130 may indicate or configure a set of transmit beams of the first network device 130 for the BFD procedure to the first terminal device 110. This set of transmit beams should comprise the transmit beams that are not affected significantly by the CLI.

In some embodiments, this set of transmit beams for the BFD procedure may be indicated implicitly. For example, the RS measurement for BFD is always use the implicit configuration for the first terminal device 110 if CLI is considered, and the first terminal device 110 performs measurements for the BFD procedure on the QCL Type-D RS (SS/PBCH or p-CSI-RS) in whatever TCI state is active for each CORESET. The first network device 130 can adjust the active TCI state for PDCCH in each Control Resource Set (CORESET) dynamically through Medium Access Control (MAC) Control Element (CE) based on the CLI measurement report. In an example, if the first terminal device 110 reports the receive beam that is QCL with the existing active TCI states for PDCCH with the measured UE-to-UE SRS-RSRP or CLI-RSSI higher than the third threshold power, then the first network device 130 can update the active TCI state for PDCCH to another TCI state configured for CORESET that has the measured CLI-RSSI or SRS-RSRP lower than the third threshold through the MAC CE. Then the BLER on a hypothetical PDCCH for BF judgment will be more accurate without or with lower CLI. In this case, in response to the CLI measurement report indicating a transmit beam in the first set of transmit beams and the transmit beam being QCL (for example, QCL Type-D) with an active Transmission Configuration Indication (TCI) state for a PDCCH, the first network device 130 transmits an updated active TCI state that is QCL with another transmit beam in the second set of transmit beams to the first terminal device 110. In this way, the first terminal device 110 may determine the transmit beams for the BFD accordingly based on receiving the updated active TCI state.

In some embodiments, this set of transmit beams for the BFD procedure may be indicated explicitly. For example, aperiodic CSI-RS can be used for BFD. Based on the CLI measurement report, the first network device 130 may trigger the CSI-RS that is not type-D QCL with the SRS that reported the CLI-SINR/RSRP higher than the third threshold. But the triggered CSI-RS is still within the same indicated TCI state as for the CORESET. In this case, the first network device 130 may transmit the CSI-RS or SSB for the BFD procedure to the first terminal device 110, the CSI-RS or SSB is not Quasi Co-Location (QCL) with a transmit beam in the first set of transmit beams. In addition or alternatively, the first network device 130 may transmit the CSI-RS or SSB that is QCL with a transmit beam in the second set of transmit beams to the first terminal device 110. In addition or alternatively, the above embodiments may be also expressed as below.

UE is not expected to perform beam failure detection
measurements on the CSI-RS/SSB for
BFD if the CSI-RS/SSB is QCL-ed, with QCL-TypeD
when applicable, with the CLI SRS
or the CLI measurement resource that has the SRS-RSRP
or CLI-SINR higher than the threshold.

In addition to indicating transmit beams for the BFD procedure, the first network device 130 may also indicate the candidate beams for the beam recovery based on the CLI measurement report. For example, the candidate beam configuration for the BFR procedure is based on the CLI measurement report, and the candidate beam comprises the transmit beam that has the measured SRS-RSSP or the RSSI/SINR lower than the fourth threshold power. In addition or alternatively, the candidate beams comprise the transmit beams of which a SINR is above the fifth threshold power. In some embodiments, the first network device 130 transmits a first list of candidate beams for a Beam Failure Recovery (BFR) procedure to the first terminal device 110. The first list of candidate beams indicates a transmit beam other than the first set of transmit beam. In addition or alternatively, the first network device 130 transmits a second list of candidate beams for the BFR procedure to the first terminal device 110. The second list of candidate beams indicates a transmit beam in the second set of transmit beams. In addition or alternatively, this embodiment may be also expressed as below.

UE is not expect to perform candidate beam detection
measurements on the SSB/CSI-RS
configured for New Beam Identification (NBI)
if the SSB/CSI-RS is QCL-ed, with
QCL-TypeD when applicable, with the CLI SRS
or the CLI measurement resource that has
the measured CLI-RSSI or the SRS-RSRP or
LI-SINR exceed the threshold.

In addition, the first network device 130 may also transmit the list of candidate beams (for example, the first or second list of candidate beams) to the second network device 140, in order to schedule the second terminal device 120 to avoid using the UL transmit beams that overlap with the candidate beams for eliminating the CLI.

Referring back to FIG. 2, the first network device 130 determines a CLI elimination configuration based on the CLI measurement report from the first terminal device 110. At 217, the first network device 130 transmits a CLI elimination configuration for the second terminal device 120 to the second network device 140 serving the second terminal device 120. The CLI elimination configuration for the second terminal device 120 indicates a list of candidate beams for the first terminal device 110, and the candidate beams are disabled for the second terminal device 120. For example, the first network device 130 and the second network device 140 may exchange information on the list of candidate beams for the BFR procedure through Xn/AMF. These candidate beams should be protected for new beam selection, and the second terminal device 120 should not be indicated to use these beams for UL transmission. In this way, the measured L1-RSRP of these candidate beams for DL new beam selection should be the actual value which is not interference by other terminal's transmission UL. In some embodiments, such as the RRC configuration of candidateBeamRSList, candidateBeamRSSCellList, candidateBeamresourceList, and candidateBeamresourceList2 is based on the CLI coordination between the network devices, and the associated candidate beams are not affected by the CLI.

At 219, the second network device 140 transmits CLI elimination configuration to the second terminal device 120. Then, the second terminal device 120 may perform UL data transmission via a transmit beam which not overlap with the beams in the candidate beams. In addition or alternatively, the second network device 140 may also transmit an indication field which is indicative of the list of candidate beams in DCI. Then, the second terminal device 120 may perform UL data transmission via a transmit beam which not overlap with the indicated candidate beams for the first terminal device 110. In addition or alternatively, the second network device 140 may also schedule the second terminal device 120 to perform UL data transmission via a transmit beam which not overlap with the indicated candidate beams for the first terminal device 110.

In addition or alternatively, the measurement parameters for the candidate beams for the BFR procedure of the terminal devices affected by the CLI may be also changed. In some embodiments, the value of rsrp-ThresholdSSB and rsrp-ThresholdBFR considering the potential influence of the CLI can be extended, for example can be increased. In some other embodiments, the measurement metric for the NBI can be changed from RSRP to SINR when CLI is considered.

In addition or alternatively, as similar as calculating the actual PDCCH hypothetical BLER in the BFD procedure, the first terminal device 110 may also perform measurements on candidate beams by separating the CLI effect. In some embodiments, the first terminal device 110 extracts a CLI-affected magnitude from a measured RSRP of the at least one of the CSI-RS or the SSB to obtain an actual RSRP for a candidate transmit beam, the at least one of the CSI-RS or the SSB corresponding to the candidate transmit beams. Then, the first terminal device 110 performs a BFR procedure based on the actual RSRP for the candidate transmit beams. In an example, candidate DL beam measurement and CLI measurement may be performed at the same time, and the CLI can be estimated and extracted from the result. For example, NBI includes the CLI measurement of each beam in the candidate beam list (for example, the first or second list of candidate beams). And each beam evaluation include the measurement of the LI-RSRP of DL SSB/CSI-RS and the measurement of the SRS-RSRP of the neighbor terminal devices, and other parameters evaluated based on these two values. Further, the measured SRS have the same QCL Type-D with the candidate SSB/CSI-RS configured for NBI. To evaluate the performance of beam pair link(s), the terminal device 110 needs to merge the measurement results of periodic SSB/CSI-RS and SRS and individually consider the measurement results.

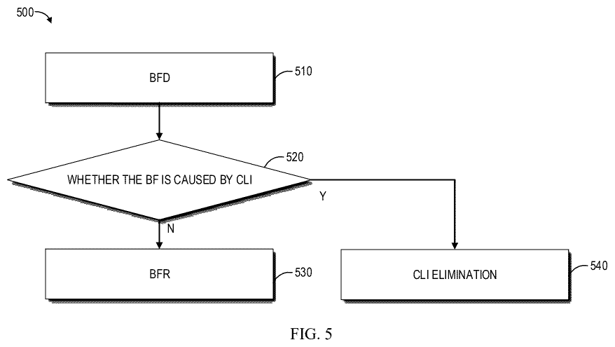

Referring back to 211, the BFR procedure may be also performed conditionally for avoiding the CLI effect. In some embodiments, in response to determining that a Beam Failure Instance (BFI) is caused by the CLI (for example, the receiving power of SRS that is QCL with a beam is above first threshold), the terminal device 110 may first perform a CLI elimination procedure for eliminating the CLI from the second terminal device. For example, the first terminal device 110 may transmit a CLI elimination request which indicates beams for the BFD procedure of the first terminal device 110 to the first network device 130. The first network device 130 and the second network device 140 may exchange the information on beams for the BFD procedure of the first terminal device 110. The second network device 140 configures the second terminal device 120 to use other transmit beams which will not affect the beams for the BFD procedure. In addition or alternatively, the first network device 130 change a DL receive beam of the first terminal device 110 and this beam switching is used to avoid the CLI. For discussion clarity, the conditional BFD procedure is discussed with reference to FIG. 5.

FIG. 5 illustrates a flowchart 500 of an example method according to some embodiments of the present disclosure.

In the flowchart 500, at 510, the first terminal device 110 performs the BFD procedure with respect to the transmit beams of the first network device 130. At 510, the first terminal device 110 determines whether a BFI or a BF is caused by the CLI. In some embodiments, the first terminal device 110 may determine a BFI or a BF happens upon the measurements or calculated values (such as, SINR or RSRP for CSI-RS) of all the beams for BFD are all lower than the threshold T1. Then, the first terminal device 110 determines whether the BFI or BF is caused by the CLI by determining CLI measurement value of all the beams for BFD are all lower than the threshold T2. If the CLI measurement values are lower than the threshold T2, the BF or BFI is determined to be caused by CLI. In this case, the terminal device 110 may perform or request CLI elimination as mentioned above. Otherwise, the first terminal device 110 may perform the BFD procedure normally. The above steps may be also shown by Table 1.

TABLE 1

| RSRP/SINR result | RSRP/SINR result of the | Judged |
|---|---|---|
| of the SSB/CSI-RS | CLI-RS | conclusion |
| The measurement | The CLI measurement value | Actually/ |
| or calculated | of all the beam for BFD are | original BFR |
| value of all the | all lower than the threshold | procedure is |
| beam for BFD | T2. | needed. |
| are all lower | The CLI measurement value | CLI solution |
| than the threshold | of at least one of the beam is | is needed. |
| T1. | higher than the threshold T2. | |

In addition or alternatively, the above embodiments may be also expressed as below.

When the radio link quality on all the RS resources
in set q̅₀ is worse than Qₒᵤₜ_LR, layer 1
of the UE do the UE-to-UE CLI measurement, and
UE report the result to gNB. If all the
beam SRS-RSRP or the CLI-RSSI is lower than
the threshold, then UE can judge that the
CLI does not exist, then UE shall send a beam
failure instance indication to the higher
layers through MAC CE, otherwise, UE not
report the BFI to the higher layer.
The UE-to-UE CLI measurement and report is
performed when the radio link quality is
worse than the threshold Q_{out, LR} with a periodicity
determined by the maximum between
the shortest periodicity among the SS/PBCH blocks
on the PCell or the PSCell and/or the
periodic CSI-RS configurations in the set
q⁻_0, q⁻_0, 0, or q⁻_0,₁ that the UE uses to assess the
radio link quality and 2 msec. In DRX mode
operation, the UE-to-UE CLI measurement
and report is performed when the radio link quality
is worse than the threshold Q_{out,LR} with
a periodicity determined as described in [10, TS 38.133].

In some embodiments, the BFI/BF event may trigger CLI-SINR measurement, and a corresponding report can be defined. The measured beams are the same as the explicit configured or implicit deduced from PDCCH QCL info for BFD beams. In some embodiments, the measured beams comprise: a first transmit beam being QCL with a CSI-RS/SSB procedure; or a second transmit beam being QCL with an active TCI state procedure. The procedure for the CLI measurement report is not the same as the normal periodic or SPS report. In addition or alternatively, the above embodiments may be also expressed as below.

On each RS resource configuration in the set q̅₀, the
UE shall measure the CLI-SINR of
the neighbor UE that has the same QCL assumption
with the RS resource q̅₀ and compare
it to the threshold, if the CLI-SINR value exceed
the threshold, then UE report the beam
index that is the same with the RS resource.
Through this UE can judge whether the
downlink radio link quality on the configured
RS resource in set q̅₀ is affected by CLI.

As mentioned above, the criterion for determining whether a BF happens under the CLI situation may be adjusted. In some embodiments, the maximum number of the BFI counter can be adjusted. In addition or alternatively, the timer for constraining the certain time period can be adjusted. In an example, as the BFD will be influenced by the CLI, and the beam failure will be declared if the BFI counter reaches the configured maximum number before the timer (for example, the beam failure recovery timer) expires or restarts. Therefore if configured beamFailureInstanceMaxCount is a small value, and the beamFailureRecoveryTimer is a large value, then the beam failure declaration will be reached easily and the BFR procedure will happen frequently, but may be it is not the case actually.

In some embodiments, the criterion for judgement BF can be relaxed. The existing parameters can be extended and/or shortened for the case if CLI is existed. For example, extending the maximum number of the BFI counter, such as the candidate value in the RRC configuration of beamFailureInstanceMaxCount can be larger values, such as extend the existing value {n1, n2, n3, n4, n5, n6, n8, n10} to {n10, n12, n13, n14, n15, n16, n18, n20}. In another example, slightly smaller value of the timer can be defined, such as beamFailureRecoveryTimer ENUMERATED {ms2, ms5, ms10, ms20, ms40, ms60, ms80}. Through this, the CLI influence on the BFD will be reduced, and the beam failure declaration will be slowed down. In addition or alternatively, the above embodiments may be also expressed as below.

If UE report the SRS-RSRP or the CLI-RSSI or
LI-SINR that are quasi co-located, as
described in [6, TS 38.214], with the DM-RS
of PDCCH receptions monitored by the UE higher
than a threshold, then UE is not expect small value of
beamFailureInstanceMaxCount and large
beamFailureRecoveryTimer are configured for
BFD.

In addition or alternatively, in some embodiments, parameters for BFR procedure may be also adjusted with respect to the CLI. The adjusted parameters comprises at least one of: Random Access Channel (RACH) parameter associated with the CLI, search space identification (ID) associated with the CLI, a first threshold power of Reference Signal Receiving Power (RSRP) for a SSB received from the first network device, the SSB corresponding to a candidate beam for the first terminal device, or a second threshold power of the RSRP for the BFR procedure. For example, new RRC parameters can be defined for configuration to the first terminal device 110 if the CLI is considered for BFR.
RACH resources configuration with CLI, it used for sending BFRQ for the BF caused by CLI.
rsrp-ThresholdSSBWithCLI and the candidate value is larger than the case without CLI.
   BeamFailureRecoverywithCLIConfig information element can be designed and added in 38.331 and the IE can include at least one of the below information:

```
BeamFailureRecoverywithCLIConfig ::= SEQUENCE
  rsrp-ThresholdBFR RSRP-Range OPTIONAL, -- Need M
  candidateBeamRSList SEQUENCE (SIZE(1..maxNrofCandidateBeams)) OPTIONAL, --
Need M
rach-ConfigWithCLI RACH-ConfigGeneric
ssb-perRACH-Occasion
rootSequenceIndex-BFR INTEGER (0..137)
beamFailureInstanceMaxCountwithCLI  ENUMERATED {n6, n8, n10, n12, n16, n20}
beamFailureRecovery TimerwithCLI ENUMERATED {ms2, ms5, ms10, ms20, ms40,}
CLI-recoverySearchSpaceId
}
```

Referring back to FIG. 2, at 221, the terminal device 110 may declare a BF based on the result of the BFD procedure. The BF judge criterion may comprise the conventional criterion, and/or the criterion adjusted for the CLI situation as mentioned above, for example, the relaxed maximum number of BFI counter and the relaxed BFI recovery timer. At 223, the first network device 130 may transmit a list of candidate beams to the first terminal device 110. The list of candidate beams may be the list of candidate beams indicated by the CLI elimination configuration at steps 217 and 219. If one in the list of the candidate beams is available, the first terminal device 110 may perform a Contention Free Random Access (CFRA) for the BFR procedure. Otherwise, the first terminal device 110 may perform the Contention Based Random Access (CBRA) for the BFR procedure.

Considering the BF event may be caused by CLI, the BFR request or BF report transmitted by the first terminal device 110 may carry additional indication information. For example, the additional indication information may indicate that the BF event is caused by the CLI, which may be also referred to as a CLI-caused BF event in this disclosure. There may be several methods of indicating CLI-caused BF event, and the methods are discussed in the following.

In some embodiments, upon determining that a BF is caused by the CLI, the first terminal device 110 transmits a PRACH preamble on a preconfigured PRACH resource dedicated to a CLI-caused BF event. The preconfigured PRACH resource is specific to the CLI-caused BF event. In this way, if the BF happens and the first terminal device 110 performs the Contention Based Random Access (CBRA), the first terminal device 110 may transmit the PRACH preamble on the preconfigured PRACH. Once receiving the PRACH preamble on this preconfigured PRACH resource, the first network device 130 may realize that the BF is caused by the CLI.

In an example, as different action will be adopted for CLI caused BF or not, then the terminal device 110 should inform the first network device 130 the BF caused by CLI or not caused by CLI. Further, the first terminal device 110 should inform the first network device 130 of which beam for the BFD or NBI is influenced or not influenced by CLI. For example, dedicated PRACH resource (including the sequence, time or frequency resource) can be configured to the first terminal device 110 for sending the BF caused by CLI. Alternatively, the PRACH resource for BF using CFRA is divided into two parts, one is for CLI-caused BF event, the other is for normal BF, and the first terminal device 110 sends the corresponding PRACH according to the CLI measurement results. In some embodiments, if the BF is caused by the CLI that is the CLI measurement results of one or more beam in the q̅₀ (a beam set) higher than the threshold, then the first terminal device 110 sends the PRACH on the PRACH resource for CLI-caused BF event. If the BFR is not related to CLI, that is all the beams in q̅₀ of UE-to-UE CLI measurement lower than the threshold, UE send the preamble on the related PRACH resource for normal BF. In addition or alternatively, a max value of the counter is configured, when the first terminal device 110 determines that the BF is caused the CLI, then the counter increments by one, and when the value of the counter reach the maximum, then the first terminal device 110 report the CLI-caused BF event to the network device 130.

In addition or alternatively, the PRACH resource is associated with a specific beam that is affected by the CLI. In some embodiments, upon determining that a BF is caused by the CLI, the first terminal device 110 transmits a PRACH preamble on a respective PRACH resource. The association between an index of at least one of a CSI-RS or a SSB corresponding to a transmit beam of the first network device 130 and the respective PRACH resource is preconfigured. The receiving power of a SRS that is QCL with the transmit beam is above a third threshold power.

In an example, the relationship between SSB/CSI-RS index and the PRACH resource/Random Access Occasion (RA) and preamble can also be defined/configured for CLI-caused BF event. Through the defined/configured RACH Ocassion (RO), the first terminal device 110 may report the top k beam(s) that has measured CLI higher (interference beam)/lower (not interference beam) than a threshold. By detecting PRACH, the first network device 130 can know which DL receive beam is affected by the CLI or not affected by the CLI. In some embodiments, two BFR sets parameters for RACH procedure are configured to the first terminal device 110, one set is for CLI-caused BF event, the other set is for actually/original BF. These parameters including ssb-per RACH-Occasion, rootSequenceIndex-BFR, prach-ConfigurationIndex. In this way, through the detected PRACH, the first network device 130 will know whether the BF is caused by the CLI, and perform corresponding operations. Moreover, the firs terminal device 110 will perform blind detection of the PDCCH on the dedicated search space to confirm the new DL receive beam. The dedicated search space is discussed in the following for details.

In addition, if all beams in the candidate beam list (for example, the first or second list of candidate beams) are lower than the RSRP threshold, then the first terminal device 110 triggers the CLI measurement procedure. If the first terminal device 110 measured all or a part of the SRS-RSRP or the CLI-RSSI of the UE-to-UE beam higher than the threshold, then the first terminal device 110 will send a MAC CE information to gNB to feedback that the beam set q̅₁ is influenced by the CLI. Otherwise if all the beam in the set with the measured SRS-RSRP or CLI-RSSI lower than the threshold, then CBRA or CFRA is triggered.

In addition or alternatively, the information on CLI-caused BF event may be carried on a Message 3 or Message A for the RACH procedure. In some embodiments, the first terminal device 110 may transmit a message carrying Medium Access Control (MAC) Control Element (CE) to the first network device 130. The MAC CE indicates a recommended transmit beam of the first network device 130. In addition, a SRS receiving power or CLI-Received Signal Strength Indicator (RSSI) associated with the recommended transmit beam is lower than a fourth threshold power. In addition or alternatively, a RSRP or a Signal to Interference plus Noise Ratio (SINR) of the recommended transmit beam is higher than a fifth threshold power. In some embodiments, the message comprises a Message 3 or a Message A for a RACH procedure.

In some embodiments, Message 3 or Message A can carry the MAC CE information that include the new beam obtained based on the UE-to-UE CLI measurement if the relationship between the CSI-RS and the RO is not defined. The selected new beam has the measured SRS-RSRP or CLI-RSSI or SINR lower than the threshold. In addition, the selected beam is selected from q̅₀ and the selected beam has the measured CSI-RS/SSB RSRP/SINR higher than the threshold. After receive Message 3 or Message A, the first network device 130 will send a response to confirm the reported beam can be used in the following. And dedicated CORESET can be defined for the first terminal device 110 to detect CLI report response, in order to reduce the resource for the PDCCH blind detection. Dedicated CORESET or search space can be defined for CLI report response to reduce the first terminal device 110 to perform PDCCH blind detection. This configuration can also be included in BFR configuration under CLI, such as CLI-recoverySearchSpaceId can be included in the BeamFailureRecoverywithCLIConfig IE. In this way, the first terminal device 110 may detect a BFR response on a search space having a preconfigured search space ID dedicated to the CLI-caused BF event. After receiving the CLI result report, the first network device 130 may adjust the active DL receive beam for the first terminal device 110 to the reported beams with low CLI-RSRP and send a PDCCH to schedule a new transmission for UL using this search space ID.

In addition or alternatively, the above embodiments may be also expressed as below.

The UE indicates to higher layers whether there
is at least one periodic CSI-RS
configuration index or SS/PBCH block index from
the set q⁻_1, or q⁻_1,0, or q⁻_1,1 that is
QCL-TypeD with the CLI SRS or the CLI
measurement resource that has the measured
SRS-RSRP or CLI-RSSI larger than or equal to
the threshold, and provides the periodic
CSI-RS configuration indexes and/or SS/PBCH
block indexes from the set q⁻_1, or q⁻_1,0, or
q⁻_1,1 and the corresponding SRS-RSRP or
CLI-RSSI measurements that are larger than or
equal to the threshold, if any.

In addition or alternatively, without any limitation, if the first terminal device 110 is served by a Secondary Cell (SCell) of the first network device 110, dedicated Scheduling Request (SR)/Physical Uplink Control Channel (PUCCH) resource can be configured to the first terminal device 110 for requesting resource for sending the BF report caused by CLI during the BFR procedure. In some embodiments, upon determining that a BF is caused by the CLI, the first terminal device 110 may transmit a SR on at least one of a preconfigured SR resource or a preconfigured a Physical Uplink Control Channel (PUCCH) resource dedicated to a CLI-caused BF event. In this way, the first network device 130 may also realize that the BF is caused by the CLI.

In an example, a new parameter schedulingRequestID-CLI can be configured through RRC to UE for request a resource for feedback the BF is caused by CLI. After detecting the PUCCH, the first network device 130 may send a UL grant to allocate the resource for report the CLI result. The allocated resource is used for feedback of the CLI measurement result and the report including the beam index that with the measured SRS-RSRP or the CLI-RSSI lower/higher than the threshold or the beam index and the related and the corresponding L1-RSRP measurements, and these measured SRS or CLI IM resource is QCL-TypeD with the periodic CSI-RS configuration indexes and/or SS/PBCH block indexes from the set q_{_1}⁻, or q_{_1,0}⁻, or q_{_1,1}⁻.

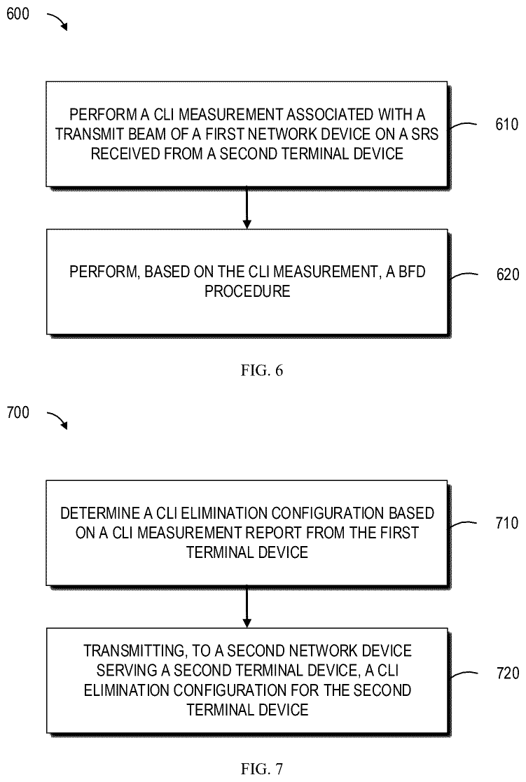

FIG. 6 illustrates a flowchart of an example method 600 implemented at a terminal device according to some embodiments of the present disclosure. The method 600 can be implemented at the first terminal device 110 shown in FIG. 1. For the purpose of discussion, the method 600 will be described with reference to FIG. 1. It is to be understood that the method 600 may include additional acts not shown and/or may omit some shown acts, and the scope of the present disclosure is not limited in this regard.

At 610, the first terminal device 110 performs a CLI measurement associated with a transmit beam of a first network device 130 on a SRS received from a second terminal device 120.

At 620, the first terminal device 110 performs, based on the CLI measurement, a BFD procedure.

In some embodiments, performing the BFD procedure comprises: extracting a CLI-affected magnitude from a Physical Downlink Control Information (PDCCH) hypothetical Block Error Rate (BLER) calculated for the transmit beam to obtain an actual PDCCH hypothetical BLER; and performing the BFD procedure based on the actual PDCCH hypothetical BLER for the transmit beam.

In some embodiments, the method 600 further comprises receiving, from the first network device, a resource configuration indicating a first resource allocated to the SRS and a second resource allocated to the at least one of a Channel State Information-Reference Signal (CSI-RS) or a Synchronization Signal Block (SSB), the first resource and the second resource being multiplexed in a frequency domain.

In some embodiments, the first resource comprises a first Resource Element (RE) set in a Resource Block (RB), and wherein the second resource comprises a second RE set in the RB, the first RE set being different from the second RE set.

In some embodiments, the method 600 further comprises transmitting a CLI measurement report to the first network device, the CLI report indicating at least one of: a first beam indication that is indicative of a first set of transmit beams of the first network device, a SRS receiving power or a CLI-Received Signal Strength Indicator (RSSI) associated with a transmit beam of the first set of transmit beams being above a first threshold; or a second beam indication that is indicative of a second set of transmit beams of the first network device, a SRS receiving power or CLI-RSSI associated with a transmit beam of the first transmit beams being lower than a second threshold.

In some embodiments, the method 600 further comprises receiving, from the first network device, at least one of: the CSI-RS or SSB for the BFD procedure, the CSI-RS or SSB being not Quasi Co-Location (QCL) with a transmit beam in the first set of transmit beams; or the CSI-RS or SSB for the BFD procedure, the CSI-RS or SSB being QCL with a transmit beam in the second set of transmit beams.

In some embodiments, the method 600 further comprises in response to the CLI measurement report indicating a transmit beam in the first set of transmit beams and the transmit beam being QCL with an active Transmission Configuration Indication (TCI) state for a PDCCH, receiving, from the first network device, an updated active TCI state being QCL with another transmit beam in the second set of transmit beams.

In some embodiments, the method 600 further comprises at least one of: receiving a first list of candidate beams for a Beam Failure Recovery (BFR) procedure, the first list of candidate beams indicating a transmit beam other than the first set of transmit beam; or receiving a second list of candidate beams for the BFR procedure, the second list of candidate beams indicating a transmit beam in the second set of transmit beams.

In some embodiments, the method 600 further comprises in response to a Beam Failure Instance (BFI), measuring the CLI of the transmit beam from the second terminal device 120.

In some embodiments, the transmit beam comprises at least one of: a first transmit beam being QCL with a CSI-RS or SSB for the BFD procedure; or a second transmit beam being QCL with an active TCL state for the BFD procedure.

In some embodiments, the method 600 further comprises in response to determining that a Beam Failure Instance (BFI) is caused by the CLI, performing a CLI elimination procedure for eliminating the CLI from the second terminal device; or in response to determining that the BFI is not caused by the CLI, transmitting a BFI indication to a higher layer.

In some embodiments, performing the BFD comprises at least one of: adjusting a maximum number of a BFI counter for counting a number of BFIs; or adjusting an expiration timing of a timer for recovering the BFI counter.

In some embodiments, performing the BFD comprises: adjusting parameters configured for a BFR procedure, wherein the parameter comprises at least one of: Random Access Channel (RACH) parameter associated with the CLI, search space identification (ID) associated with the CLI, a first threshold power of Reference Signal Receiving Power (RSRP) for a SSB received from the first network device, the SSB corresponding to a candidate beam for the first terminal device, or a second threshold power of the RSRP for the BFR procedure.

In some embodiments, the method 600 further comprises extracting a CLI-affected magnitude from a measured RSRP of the at least one of the CSI-RS or the SSB to obtain an actual RSRP for a candidate transmit beam, the at least one of the CSI-RS or the SSB corresponding to the candidate transmit beams; and performing a BFR procedure based on the actual RSRP for the candidate transmit beams.

In some embodiments, the method 600 further comprises in response to determining that a Beam Failure (BF) is caused by the CLI, transmitting a RACH preamble on a preconfigured RACH resource dedicated to a CLI-caused BF event.

In some embodiments, the method 600 further comprises in response to determining that a BF is caused by the CLI, transmitting a RACH preamble on a respective RACH resource, wherein an association between an index of at least one of a CSI-RS or a SSB corresponding to a transmit beam and the respective RACH resource is preconfigured, wherein a receiving power of a SRS is above a third threshold power and wherein the SRS is QCL with the transmit beam.

In some embodiments, the method 600 further comprises in response to determining that a BF is caused by the CLI, transmitting a Scheduling Request (SR) on at least one of a preconfigured SR resource or a preconfigured a Physical Uplink Control Channel (PUCCH) resource dedicated to a CLI-caused BF event.

In some embodiments, the method 600 further comprises transmitting, to the first network device, a message carrying Medium Access Control (MAC) Control Element (CE), the MAC CE indicating a recommended transmit beam of the first network device, wherein at least one of: a SRS receiving power or CLI-Received Signal Strength Indicator (RSSI) associated with the recommended transmit beam is lower than a fourth threshold power, or a RSRP or a Signal to Interference plus Noise Ratio (SINR) of the recommended transmit beam is higher than a fifth threshold power.

In some embodiments, the message comprises a Message 3 or a Message A for a RACH procedure.

In some embodiments, the method 600 further comprises detecting a BFR response on a search space having a preconfigured search space ID dedicated to the CLI-caused BF event.

FIG. 7 illustrates a flowchart of a method 700 of communication implemented at a network device in accordance with some embodiments of the present disclosure. The method 700 can be implemented at the first network terminal device 130 shown in FIG. 1. For the purpose of discussion, the method 700 will be described with reference to FIG. 1. It is to be understood that the method 700 may include additional acts not shown and/or may omit some shown acts, and the scope of the present disclosure is not limited in this regard.

At 710, the first network device 130 determines a CLI elimination configuration based on a CLI measurement report from the first terminal device 110.

At 720, the first network device 130 transmits, to a second network device 140 serving a second terminal device 120, a CLI elimination configuration for the second terminal device 120, the CLI elimination configuration indicating a list of candidate beams for the first terminal device 110. The candidate beams are disabled for the second terminal device 120.

In some embodiments, the method 700 further comprises receiving, from the second network device 140, a SRS resource configuration for the second terminal device 120.

In some embodiments, the method 700 further comprises transmitting, based on the SRS resource configuration and to the first terminal device, a resource configuration indicating a first resource allocated to the SRS and a second resource allocated to the at least one of the CSI-RS or the SSB, the first resource and the second resource being multiplexed in a frequency domain.

In some embodiments, the first resource comprises a first Resource Element (RE) in a Resource Block (RB), and wherein the second resource comprises a second RE in the RB, the first RE being different from the second RE.

In some embodiments, the CLI report indicates at least one of: a first beam indication that is indicative of a first set of transmit beams of the first network device, a SRS receiving power or a CLI-Received Signal Strength Indicator (RSSI) associated with a transmit beam of the first set of transmit beams being above a first threshold; or a second beam indication that is indicative of a second set of transmit beams of the first network device, a SRS receiving power or CLI-Received Signal Strength Indicator (RSSI) associated with a transmit beam of the first transmit beams being lower than a second threshold.

In some embodiments, the method 700 further comprises transmitting, to the first terminal device, at least one of: the CSI-RS or SSB for the BFD procedure, the CSI-RS or SSB being not Quasi Co-Location (QCL) with a transmit beam in the first set of transmit beams; or the CSI-RS or SSB for the BFD procedure, the CSI-RS or SSB being QCL with a transmit beam in the second set of transmit beams.

In some embodiments, the method 700 further comprises in response to the CLI measurement report indicating a transmit beam in the first set of transmit beams and the transmit beam being QCL with an active TCI state for PDCCH, transmitting, to the first terminal device 110, an updated active TCI state being QCL with another transmit beam in the second set of transmit beams.

In some embodiments, the method 700 further comprises at least one of: transmitting a first list of candidate beams for a Beam Failure Recovery (BFR) procedure, the first list of candidate beams indicating a transmit beam other than the first set of transmit beam; or transmitting a second list of candidate beams for the BFR procedure, the second list of candidate beams indicating a transmit beam in the second set of transmit beams.

In some embodiments, the method 700 further comprises receiving a RACH preamble on a preconfigured RACH resource dedicated to a CLI-caused BF event; and determining that a BF is caused by the CLI.

In some embodiments, the method 700 further comprises receiving a RACH preamble on a respective RACH resource, wherein an association between an index of at least one of a CSI-RS or a SSB corresponding to a transmit beam and the respective RACH resource is preconfigured, wherein an SRS receiving power of a SRS is above a third threshold power and wherein the SRS is QCL with the transmit beam; and determining that the transmit beam corresponding to the at least one of the CSI-RS or the SSB is affected by the CLI.

In some embodiments, the method 700 further comprises receiving a Scheduling Request (SR) on at least one of a preconfigured SR resource or a preconfigured a Physical Uplink Control Channel (PUCCH) resource dedicated to a CLI-caused BF event; and determining that a BF is caused by the CLI.

In some embodiments, the method 700 further comprises receiving, from the first terminal device, a message carrying Medium Access Control (MAC) Control Element (CE), the MAC CE indicating a recommended transmit beam of the first network device, wherein at least one of: a SRS receiving power or RSSI associated with the recommended transmit beam is lower than a fourth threshold power, or a RSRP or a Signal to Interference plus Noise Ratio (SINR) of the recommended transmit beam is higher than a fifth threshold power.

In some embodiments, the message comprises a Message 3 or a Message A for a RACH procedure.

In some embodiments, the method 700 further comprises transmitting a BFR response for the SR on a search space having a preconfigured search space ID dedicated to the CLI-caused BF event.

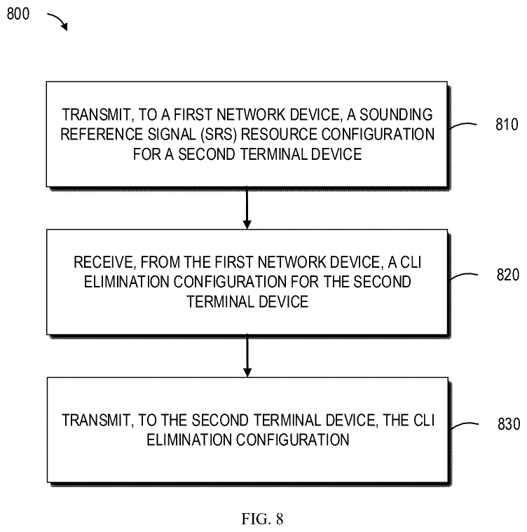

FIG. 8 illustrates a flowchart of a method 800 of communication implemented at a network device in accordance with some embodiments of the present disclosure. The method 800 can be implemented at the second network device 140 shown in FIG. 1. For the purpose of discussion, the method 800 will be described with reference to FIG. 1. It is to be understood that the method 800 may include additional acts not shown and/or may omit some shown acts, and the scope of the present disclosure is not limited in this regard.

At 810, the second network device 140 transmits a SRS resource configuration for a second terminal device 120 to the first network device 130.

At 820, the second network device 140 receives, from the first network device 130, a CLI elimination configuration for the second terminal device 120. The CLI elimination configuration indicates a list of candidate beams for the first terminal device 110. The candidate beams are disabled for the second terminal device 120.

At 830, the second network device 140 transmits, to the second terminal device 120, the CLI elimination configuration.

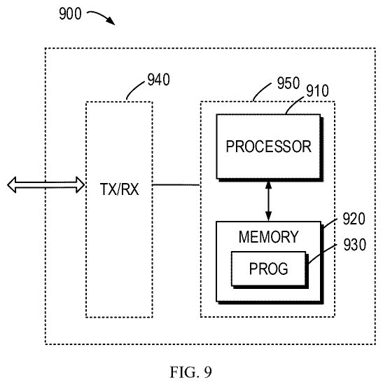

FIG. 9 is a simplified block diagram of a device 900 that is suitable for implementing some embodiments of the present disclosure. The device 900 can be considered as a further example embodiment of the network devices 130 and 140 as shown in FIG. 1, or terminal devices 110 and 120 as shown in FIG. 1. Accordingly, the device 900 can be implemented at or as at least a part of the above network devices or terminal devices.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 930 is assumed to include program instructions that, when executed by the associated processor 910, enable the device 900 to operate in accordance with the embodiments of the present disclosure, as discussed herein with reference to FIGS. 2-8. The embodiments herein may be implemented by computer software executable by the processor 1910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 1210 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises circuitry configured to perform method 600.

In some embodiments, a network device comprises circuitry configured to perform method 700 and/or 800.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A method of communication, comprising: performing, at a first terminal device, a Cross Link Interference (CLI) measurement associated with a transmit beam of a first network device on a Sounding Reference Signal (SRS) received from a second terminal device; and performing, based on the CLI measurement, a Beam Failure Detection (BFD) procedure.

In one embodiment, wherein performing the BFD procedure comprises: extracting a CLI-affected magnitude from a Physical Downlink Control Information (PDCCH) hypothetical Block Error Rate (BLER) calculated for the transmit beam to obtain an actual PDCCH hypothetical BLER; and performing the BFD procedure based on the actual PDCCH hypothetical BLER for the transmit beam.

In one embodiment, further comprising: receiving, from the first network device, a resource configuration indicating a first resource allocated to the SRS and a second resource allocated to the at least one of a Channel State Information-Reference Signal (CSI-RS) or a Synchronization Signal Block (SSB), the first resource and the second resource being multiplexed in a frequency domain.

In one embodiment, wherein the first resource comprises a first Resource Element (RE) set in a Resource Block (RB), and wherein the second resource comprises a second RE set in the RB, the first RE set being different from the second RE set.

In one embodiment, further comprising transmitting a CLI measurement report to the first network device, the CLI report indicating at least one of: a first beam indication that is indicative of a first set of transmit beams of the first network device, a SRS receiving power or a CLI-Received Signal Strength Indicator (RSSI) associated with a transmit beam of the first set of transmit beams being above a first threshold; or a second beam indication that is indicative of a second set of transmit beams of the first network device, a SRS receiving power or CLI-RSSI associated with a transmit beam of the first transmit beams being lower than a second threshold.

In one embodiment, further comprising receiving, from the first network device, at least one of: the CSI-RS or SSB for the BFD procedure, the CSI-RS or SSB being not Quasi Co-Location (QCL) with a transmit beam in the first set of transmit beams; or the CSI-RS or SSB for the BFD procedure, the CSI-RS or SSB being QCL with a transmit beam in the second set of transmit beams.

In one embodiment, further comprising: in response to the CLI measurement report indicating a transmit beam in the first set of transmit beams and the transmit beam being QCL with an active Transmission Configuration Indication (TCI) state for a PDCCH, receiving, from the first network device, an updated active TCI state being QCL with another transmit beam in the second set of transmit beams.

In one embodiment, further comprising at least one of: receiving a first list of candidate beams for a Beam Failure Recovery (BFR) procedure, the first list of candidate beams indicating a transmit beam other than the first set of transmit beam; or receiving a second list of candidate beams for the BFR procedure, the second list of candidate beams indicating a transmit beam in the second set of transmit beams.

In one embodiment, further comprising: in response to a Beam Failure Instance (BFI), measuring the CLI of transmit beam from the second terminal device.

In one embodiment, wherein the transmit beam comprises at least one of: a first transmit beam being QCL with a CSI-RS or SSB for the BFD procedure; or a second transmit beam being QCL with an active TCL state for the BFD procedure.

In one embodiment, further comprising: in response to determining that a Beam Failure Instance (BFI) is caused by the CLI, performing a CLI elimination procedure for eliminating the CLI from the second terminal device; or in response to determining that the BFI is not caused by the CLI, transmitting a BFI indication to a higher layer.

In one embodiment, wherein performing the BFD comprises at least one of: adjusting a maximum number of a BFI counter for counting a number of BFIs; or adjusting an expiration timing of a timer for recovering the BFI counter.

In one embodiment, wherein performing the BFD comprises: adjusting parameters configured for a BFR procedure, wherein the parameter comprises at least one of: Random Access Channel (RACH) parameter associated with the CLI, search space identification (ID) associated with the CLI, a first threshold power of Reference Signal Receiving Power (RSRP) for a SSB received from the first network device, the SSB corresponding to a candidate beam for the first terminal device, or a second threshold power of the RSRP for the BFR procedure.

In one embodiment, further comprising: extracting a CLI-affected magnitude from a measured RSRP of the at least one of the CSI-RS or the SSB to obtain an actual RSRP for a candidate transmit beam, the at least one of the CSI-RS or the SSB corresponding to the candidate transmit beams; and performing a BFR procedure based on the actual RSRP for the candidate transmit beams.

In one embodiment, further comprising: in response to determining that a Beam Failure (BF) is caused by the CLI, transmitting a RACH preamble on a preconfigured RACH resource dedicated to a CLI-caused BF event.

In one embodiment, further comprising: in response to determining that a BF is caused by the CLI, transmitting a RACH preamble on a respective RACH resource, wherein an association between an index of at least one of a CSI-RS or a SSB corresponding to a transmit beam and the respective RACH resource is preconfigured, and wherein a receiving power of a SRS is above a third threshold power and wherein the SRS is QCL with the transmit beam.

In one embodiment, further comprising: in response to determining that a BF is caused by the CLI, transmitting a Scheduling Request (SR) on at least one of a preconfigured SR resource or a preconfigured a Physical Uplink Control Channel (PUCCH) resource dedicated to a CLI-caused BF event.

In one embodiment, further comprising: transmitting, to the first network device, a message carrying Medium Access Control (MAC) Control Element (CE), the MAC CE indicating a recommended transmit beam of the first network device, wherein at least one of: a SRS receiving power or CLI-Received Signal Strength Indicator (RSSI) associated with the recommended transmit beam is lower than a fourth threshold power, or a RSRP or a Signal to Interference plus Noise Ratio (SINR) of the recommended transmit beam is higher than a fifth threshold power.

In one embodiment, wherein the message comprises a Message 3 or a Message A for a RACH procedure.

In one embodiment, further comprising: detecting a BFR response on a search space having a preconfigured search space ID dedicated to the CLI-caused BF event.

A method of communication, comprising: determining, at a first network device serving a first terminal device, a CLI elimination configuration based on a CLI measurement report from the first terminal device; and transmitting, to a second network device serving a second terminal device, a CLI elimination configuration for the second terminal device, the CLI elimination configuration indicating a list of candidate beams for the first terminal device, the candidate beams being disabled for the second terminal device.

In one embodiment, further comprising: receiving, from the second network device, a Sounding Reference Signal (SRS) resource configuration for the second terminal device.

In one embodiment, further comprising: transmitting, based on the SRS resource configuration and to the first terminal device, a resource configuration indicating a first resource allocated to the SRS and a second resource allocated to the at least one of a Channel State Information-Reference Signal (CSI-RS) or a Synchronization Signal Block (SSB), the first resource and the second resource being multiplexed in a frequency domain.

In one embodiment, wherein the first resource comprises a first Resource Element (RE) set in a Resource Block (RB), and wherein the second resource comprises a second RE set in the RB, the first RE set being different from the second RE set.

In one embodiment, wherein the CLI report indicates at least one of: a first beam indication that is indicative of a first set of transmit beams of the first network device, a SRS receiving power or a CLI-Received Signal Strength Indicator (RSSI) associated with a transmit beam of the first set of transmit beams being above a first threshold; or a second beam indication that is indicative of a second set of transmit beams of the first network device, a SRS receiving power or CLI-Received Signal Strength Indicator (RSSI) associated with a transmit beam of the first transmit beams being lower than a second threshold.

In one embodiment, further comprising transmitting, to the first terminal device, at least one of: the CSI-RS/SSB for the BFD procedure, the CSI-RS/SSB being not Quasi Co-Location (QCL) with a transmit beam in the first set of transmit beams; or the CSI-RS/SSB for the BFD procedure, the CSI-RS/SSB being QCL with a transmit beam in the second set of transmit beams.

In one embodiment, further comprising: in response to the CLI measurement report indicating a transmit beam in the first set of transmit beams and the transmit beam being QCL with an active Transmission Configuration Indication (TCI) state for Physical Downlink Control Channel (PDCCH), transmitting, to the first terminal device, an updated active TCI state being QCL with another transmit beam in the second set of transmit beams.

In one embodiment, further comprising at least one of: transmitting a first list of candidate beams for a Beam Failure Recovery (BFR) procedure, the first list of candidate beams indicating a transmit beam other than the first set of transmit beam; or transmitting a second list of candidate beams for the BFR procedure, the second list of candidate beams indicating a transmit beam in the second set of transmit beams.

In one embodiment, further comprising: receiving a RACH preamble on a preconfigured RACH resource dedicated to a CLI-caused BF event; and determining that a BF is caused by the CLI.

In one embodiment, further comprising: receiving a RACH preamble on a respective RACH resource, wherein an association between an index of at least one of a CSI-RS or a SSB corresponding to a transmit beam and the respective RACH resource is preconfigured, and wherein an SRS receiving power of a SRS is above a third threshold power and wherein the SRS is QCL with the transmit beam; and determining that the transmit beam corresponding to the at least one of the CSI-RS or the SSB is affected by the CLI.

In one embodiment, further comprising: receiving a Scheduling Request (SR) on at least one of a preconfigured SR resource or a preconfigured a Physical Uplink Control Channel (PUCCH) resource dedicated to a CLI-caused BF event; and determining that a BF is caused by the CLI.

In one embodiment, further comprising: receiving, from the first terminal device, a message carrying Medium Access Control (MAC) Control Element (CE), the MAC CE indicating a recommended transmit beam of the first network device, wherein at least one of: a SRS receiving power or CLI-Received Signal Strength Indicator (RSSI) associated with the recommended transmit beam is lower than a fourth threshold power, or a RSRP or a Signal to Interference plus Noise Ratio (SINR) of the recommended transmit beam is higher than a fifth threshold power.

In one embodiment, wherein the message comprises a Message 3 or a Message A for a RACH procedure.

In one embodiment, further comprising: transmitting a BFR response for the SR on a search space having a preconfigured search space ID dedicated to the CLI-caused BF event.

A method of communication, comprising: transmitting, at a second network device to a first network device, a Sounding Reference Signal (SRS) resource configuration for a second terminal device; receiving, from the first network device, a Cross Link Interference (CLI) elimination configuration for the second terminal device, the CLI elimination configuration indicating a list of candidate beams for the first terminal device, the candidate beams being disabled for the second terminal device; and transmitting, to the second terminal device, the CLI elimination configuration.

A terminal device comprising: a processor; and a memory coupled to the processor and storing instructions thereon, the instructions, when executed by the processor, causing the terminal device to perform the method according to above methods of communication.

A network device comprising: a processor; and a memory coupled to the processor and storing instructions thereon, the instructions, when executed by the processor, causing the network device to perform the method according to above methods of communication.

A computer readable medium having instructions stored thereon, the instructions, when executed on at least one processor, causing the at least one processor to perform the method according to above methods of communication.

What is claimed is:

1. A method of communication, comprising:
performing, at a first terminal device, a Cross Link Interference (CLI) measurement associated with a transmit beam of a first network device on a Sounding Reference Signal (SRS) received from a second terminal device; and
performing, based on the CLI measurement, a Beam Failure Detection (BFD) procedure.

2. The method of claim 1, wherein performing the BFD procedure comprises:
extracting a CLI-affected magnitude from a Physical Downlink Control Information (PDCCH) hypothetical Block Error Rate (BLER) calculated for the transmit beam to obtain an actual PDCCH hypothetical BLER; and
performing the BFD procedure based on the actual PDCCH hypothetical BLER for the transmit beam.

3. The method of claim 2, further comprising:
receiving, from the first network device, a resource configuration indicating a first resource allocated to the SRS and a second resource allocated to the at least one of a Channel State Information-Reference Signal (CSI-RS) or a Sychronization Signal Block (SSB), the first resource and the second resource being multiplexed in a frequency domain.

4. The method of claim 3, wherein the first resource comprises a first Resource Element (RE) set in a Resource Block (RB), and wherein the second resource comprises a second RE set in the RB, the first RE set being different from the second RE set.

5. The method of claim 1, further comprising transmitting a CLI measurement report to the first network device, the CLI report indicating at least one of:
a first beam indication that is indicative of a first set of transmit beams of the first network device, a SRS receiving power or a CLI-Received Signal Strength Indicator (RSSI) associated with a transmit beam of the first set of transmit beams being above a first threshold; or
a second beam indication that is indicative of a second set of transmit beams of the first network device, a SRS receiving power or CLI-RSSI associated with a transmit beam of the first transmit beams being lower than a second threshold.

6. The method of claim 5, further comprising receiving, from the first network device, at least one of:
the CSI-RS or SSB for the BFD procedure, the CSI-RS or SSB being not Quasi Co-Location (QCL) with a transmit beam in the first set of transmit beams; or
the CSI-RS or SSB for the BFD procedure, the CSI-RS or SSB being QCL with a transmit beam in the second set of transmit beams.

7. The method of claim 5, further comprising:
in response to the CLI measurement report indicating a transmit beam in the first set of transmit beams and the transmit beam being QCL with an active Transmission Configuration Indication (TCI) state for a PDCCH, receiving, from the first network device, an updated active TCI state being QCL with another transmit beam in the second set of transmit beams.

8. The method of claim 5, further comprising at least one of:
receiving a first list of candidate beams for a Beam Failure Recovery (BFR) procedure, the first list of candidate beams indicating a transmit beam other than the first set of transmit beams; or
receiving a second list of candidate beams for the BFR procedure, the second list of candidate beams indicating a transmit beam in the second set of transmit beams.

9. The method of claim 1, further comprising:
in response to a Beam Failure Instance (BFI), measuring the CLI of transmit beam from the second terminal device.

10. The method of claim 9, wherein the transmit beam comprises at least one of:
a first transmit beam being QCL with a CSI-RS or SSB for the BFD procedure; or
a second transmit beam being QCL with an active TCL state for the BFD procedure.

11. The method of claim 1, further comprising:
in response to determining that a Beam Failure Instance (BFI) is caused by the CLI, performing a CLI elimination procedure for eliminating the CLI from the second terminal device; or
in response to determining that the BFI is not caused by the CLI, transmitting a BFI indication to a higher layer.

12. The method of claim 1, wherein performing the BFD comprises at least one of:
adjusting a maximum number of a BFI counter for counting a number of BFIs; or
adjusting an expiration timing of a timer for recovering the BFI counter.

13. The method of claim 1, wherein performing the BFD comprises:
adjusting parameters configured for a BFR procedure, wherein the parameter comprises at least one of:
Random Access Channel (RACH) parameter associated with the CLI,
search space identification (ID) associated with the CLI,
a first threshold power of Reference Signal Receiving Power (RSRP) for a SSB received from the first network device, the SSB corresponding to a candidate beam for the first terminal device, or
a second threshold power of the RSRP for the BFR procedure.

14. The method of claim 1, further comprising:
extracting a CLI-affected magnitude from a measured RSRP of the at least one of the CSI-RS or the SSB to obtain an actual RSRP for a candidate transmit beam, the at least one of the CSI-RS or the SSB corresponding to the candidate transmit beams; and
performing a BFR procedure based on the actual RSRP for the candidate transmit beams.

15. The method of claim 1, further comprising:
in response to determining that a Beam Failure (BF) is caused by the CLI, transmitting a RACH preamble on a preconfigured RACH resource dedicated to a CLI-caused BF event.

16. The method of claim 1, further comprising:
in response to determining that a BF is caused by the CLI, transmitting a RACH preamble on a respective RACH resource, wherein an association between an index of at least one of a CSI-RS or a SSB corresponding to a transmit beam and the respective RACH resource is preconfigured, wherein a receiving power of a SRS is above a third threshold power and wherein the SRS is QCL with the transmit beam.

17. The method of claim 1, further comprising:
in response to determining that a BF is caused by the CLI, transmitting a Scheduling Request (SR) on at least one of a preconfigured SR resource or a preconfigured a Physical Uplink Control Channel (PUCCH) resource dedicated to a CLI-caused BF event.

18. The method of claim 1, further comprising:
transmitting, to the first network device, a message carrying Medium Access Control (MAC) Control Element (CE), the MAC CE indicating a recommended transmit beam of the first network device, wherein at least one of:
a SRS receiving power or CLI-Received Signal Strength Indicator (RSSI) associated with the recommended transmit beam is lower than a fourth threshold power, or
a RSRP or a Signal to Interference plus Noise Ratio (SINR) of the recommended transmit beam is higher than a fifth threshold power.

19. The method of claim 18, wherein the message comprises a Message 3 or a Message A for a RACH procedure.

20. The method of any of claims 15-20, further comprising:
detecting a BFR response on a search space having a preconfigured search space ID dedicated to the CLI-caused BF event.
